(19) United States
(12) Patent Application Publication
(10) Pub. No.: US 2026/0238016 A1
(43) Pub. Date: Aug. 13, 2026

(54) INVERTER AND MAIN CONTROLLER FOR PHOTOVOLTAIC POWER GENERATION SYSTEM, AND OPERATING METHOD FOR PHOTOVOLTAIC SYSTEM

(71) Applicant: HANWHA SOLUTIONS CORPORATION, Seoul (KR)

(72) Inventors: Il Kyu PARK, Seoul (KR); Jong Hyun PARK, Seoul (KR); Ji Won SHIN, Seoul (KR); Yun Suk CHOI, Seoul (KR); Ju Hwan YUN, Seoul (KR)

(73) Assignee: HANWHA SOLUTIONS CORPORATION, Seoul (KR)

(21) Appl. No.: 19/154,991

(22) PCT Filed: Mar. 25, 2024
(86) PCT No.: PCT/KR2024/003690

§ 371 Date: Aug. 8, 2025

(30) Foreign Application Priority Data
Mar. 23, 2023 (KR) 10-2023-0038259

(51) Int. Cl. H02J 3/38; H02J 3/001; H02J 101/24; H02S 50/00

(52) U.S. Cl. CPC H02J 3/38; H02J 3/001; H02S 50/00; H02J 2101/25

(57) ABSTRACT

According to an embodiment of the present invention, provided is an operating method for a photovoltaic power generation system, the operating method comprising the steps of: determining the occurrence of an abnormal situation of the photovoltaic power generation system; gradually ramp-voltage-downing an output voltage of at least one of a plurality of module level power electronics (MLPE); deriving a maximum power point tracking (MPPT) control voltage of an inverter on the basis of the output voltage of the at least one MLPE; and shutting down all of the plurality of MLPE.

### TECHNICAL FIELD

The present disclosure relates to an inverter and a primary controller of a photovoltaic power generation system, and a photovoltaic power generation method, and more specifically, to a module-level power conversion device capable of preventing damage to components when power is cut off, an inverter and a primary controller of a photovoltaic generation system including the module-based power conversion device, and a photovoltaic power generation method.

### BACKGROUND ART

For photovoltaic generation systems, stability has to be secured by making real-time determination of abnormal states and emergency situations that may occur during operation. in the event of an abnormal situation in a photovoltaic generation system, an inverter or a primary controller including the inverter needs to detect the error within a very short time and perform a protective action to cut off the power.

In this regard, the National Electric Code (NEC) 2014 or NEC 2017, which is a standard for safe installation of electrical wiring and equipment applied in North America including the United States, defines components and protocols to meet the rapid shutdown (RSD) requirements of photovoltaic power generation systems.

Meanwhile, recent photovoltaic power generation systems are introducing a module-level power electronics (MLPE) device (or a unit power control device) to improve the performance of photovoltaic (PV) modules under specific conditions, such as when there is shading, and to increase power generation efficiency.

Even in case that the inverter abruptly shuts down the output of a plurality of MLPE devices in abnormal states and emergency situations through situation monitoring during operation, there is a time difference between the MLPE devices until the actual shutdown.

However, as the inverter or the primary controller including the inverter holds the total output voltage of the plurality of MLPE devices at a fixed voltage such that the MLPE devices may perform a maximum power point tracking (MPPT) operation, a voltage surge phenomenon occurs in the MLPE device shut down late. As a result, an overvoltage is applied to the MLPE shut down late, causing product damage, etc.

### DISCLOSURE

### Technical Problem

The present disclosure provides a module-level power conversion device that prevents damage to components when power is cut off to ensure system safety, a photovoltaic power generation system including the module-level power conversion device, and a method of preventing damage to the photovoltaic power generation system.

### Technical Solution

According to an embodiment of the present disclosure, an operating method of a photovoltaic power generation system includes determining whether an abnormal situation occurs in the photovoltaic power generation system, gradually ramping down an output voltage of one or more module-level power electronics (MLPE) devices among a plurality of MLPE devices, inducing a maximum power point tracking (MPPT) control voltage of an inverter, based on the output voltage of the one or more MLPE devices, and all of the plurality of MLPE devices being shut down.

In some embodiments, the inducing of the MPPT control voltage of the inverter may include gradually ramping down the MPPT control voltage of the inverter to correspond to a gradual ramp-down of the output voltage of the one or more MLPE devices.

In some embodiments, the gradual ramping down of the output voltage of the one or more of the MLPE devices may include controlling a duty ratio of a direct current-to-direct current (DC-DC) converter provided in the one or more MLPE devices according to a shutdown signal in response to the occurrence of the abnormal situation in the photovoltaic power generation system.

In some embodiments, the duty ratio of the DC-DC converter may be controlled to decrease from 1 to 0 over time.

In some embodiments, the MPPT control voltage of the inverter may start to be ramped down from a second point in time after a lapse of a selected time from a first point in time at which an output voltage of one of the plurality of MLPE devices starts to be ramped down.

In some embodiments, an output voltage of one or more MLPE devices which are not shut down during a period between the first point in time and the second point in time may increases in response to the MPPT control voltage of the inverter.

In some embodiments, the plurality of MLPE devices may be connected in series with each other.

In some embodiments, output voltages of the plurality of MLPE devices may not exceed a preset value from a point in time at which the abnormal situation occurs in the photovoltaic power generation system until a point in time at which all of the plurality of MLPE devices are shut down.

According to another embodiment of the present disclosure, an inverter for a photovoltaic power generation system includes a power conversion circuit and a processor, in which the processor is configured to determine whether an abnormal situation occurs in the photovoltaic power generation system, gradually ramp down an output voltage of one or more module-level power electronics (MLPE) devices among a plurality of MLPE devices, and induce a gradual ramp-down of a maximum power point tracking (MPPT) control voltage of an inverter, based on the output voltage of the one or more MLPE devices.

In some embodiments, the processor may be further configured to control a duty ratio of a direct current-to-direct current (DC-DC) converter provided in the one or more MLPE devices to induce the inverter to lower the MPPT control voltage in response to the output voltage of the one or more MLPE device being lowered, in case that a shutdown signal for cutting off power is generated upon the occurrence of the abnormal situation.

In some embodiments, the duty ratio of the DC-DC converter may be controlled to decrease from 1 to 0 over time.

In some embodiments, the plurality of MLPE devices may be configured to optimize an output voltage of a photovoltaic module connected to the plurality of MLPE devices with an output voltage of each MLPE device through an MPPT operation.

In some embodiments, the output voltage of the one or more MLPE devices among the plurality of MLPE devices may be gradually ramped down from a first point in time at which a duty ratio control operation starts according to a shutdown signal.

In the present invention, the inverter may be further configured to gradually lower the MPPT control voltage in response to the output voltage of the at least one MLPE device from a second point in time at which an MPPT control operation starts after a selected time from the first point in time.

In some embodiments, an output voltage of an MLPE device which is not shut down among the plurality of MLPE devices may instantaneously increase between the first point in time and the second point in time in response to the MPPT control voltage of the inverter.

In some embodiments, the plurality of MLPE devices may be connected in series with each other.

In some embodiments, output voltages of the plurality of MLPE devices may not exceed a preset value from a point in time at which the abnormal situation occurs in the photovoltaic power generation system until a point in time at which all of the plurality of MLPE devices are shut down.

According to another embodiment of the present disclosure, a primary controller of a photovoltaic power generation system includes a communication unit configured to transmit a control signal to a plurality of module-level power electronics (MLPE) devices and receive a monitoring signal from the plurality of MLPE devices and a processor configured to determine whether an abnormal situation occurs in the photovoltaic power generation system, gradually ramp down an output voltage of one or more MLPE devices among the plurality of MLPE devices, and induce a gradual ramp-down of a maximum power point tracking (MPPT) control voltage of an inverter, based on the output voltage of the one or more MLPE devices.

### Advantageous Effects

According to an embodiment of the present disclosure, it is possible to prevent damage to components due to an instantaneous overvoltage in a rapid shutdown situation.

According to an embodiment of the present disclosure, as a direct current-to-direct current (DC-DC) converter already built into an MLPE device is used for power optimization, overvoltage prevention and damage prevention may be performed without an additional component, which is efficient.

According to an embodiment of the present disclosure, the present disclosure is an economical and universal technology that is applicable even in case that manufacturers of a PV module, an MLPE device, and an inverter are different from one another.

### DESCRIPTION OF DRAWINGS

FIG. 1 is a schematic diagram of a photovoltaic power generation system according to an embodiment of the present disclosure.

FIGS. 2A and 2B are views for describing damage that may occur during shutdown in a photovoltaic system.

FIG. 3 is a flowchart of an example of an operating method of a photovoltaic system according to an embodiment of the present disclosure.

FIG. 4 is a block diagram of a module-level power electronics (MLPE) device according to an embodiment of the present disclosure.

FIG. 5 is a graph for describing operations of an inverter and an MLPE device in the event of an abnormal situation in a photovoltaic system according to an embodiment of the present disclosure.

FIG. 6 is a graph for describing operations of an inverter and an MLPE device in the event of an abnormal situation in a system according to another embodiment of the present disclosure.

FIG. 7 is a circuit diagram of a direct current-to-direct current (DC-DC) converter of an MLPE device according to an embodiment of the present disclosure.

FIG. 8 is a graph showing an output voltage of an MLPE device with respect to duty ratio control according to an embodiment of the present disclosure.

### MODE FOR INVENTION

The terms used in the embodiments are general terms that are currently widely used as much as possible, but may vary depending on the intention or precedent of a person working in the art, the emergence of new technology, etc. In addition, in a specific case, the applicant voluntarily may select terms, and in this case, the meaning of the terms may be disclosed in a corresponding description part of the present disclosure. Thus, the terms used in herein should be defined not by the simple names of the terms but by the meaning of the terms and the contents throughout the specification.

Throughout the entirety of the specification of the present disclosure, when it is assumed that a certain part includes a certain component, the term ‘including’ means that a corresponding component may further include other components unless specially described to the contrary.

In addition, terminology, such as “first” or “second” used herein, can be used to describe various components, but the components should not be limited by the terms. These terms are used to distinguish one component from another component.

Below, the embodiments are described in detail with reference to the attached drawings. However, the embodiments may be implemented in various forms, and are not limited to examples described herein.

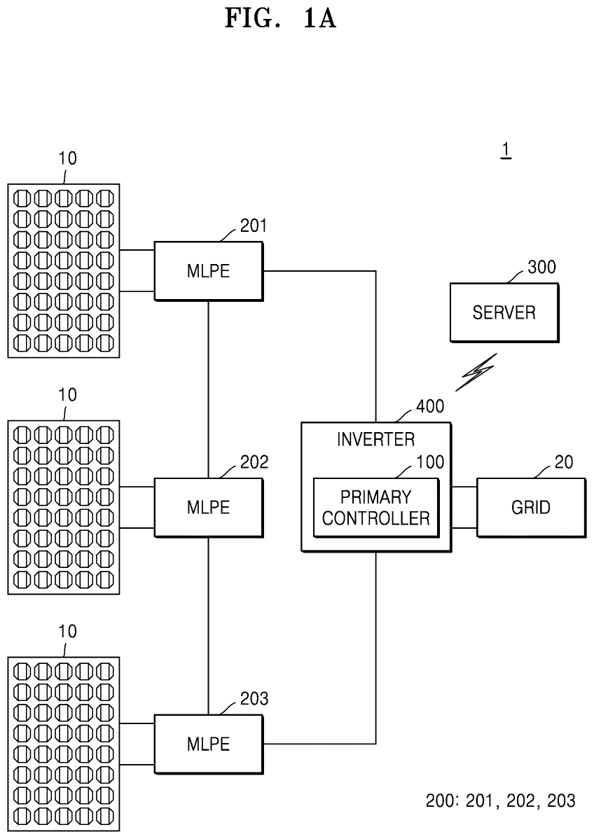

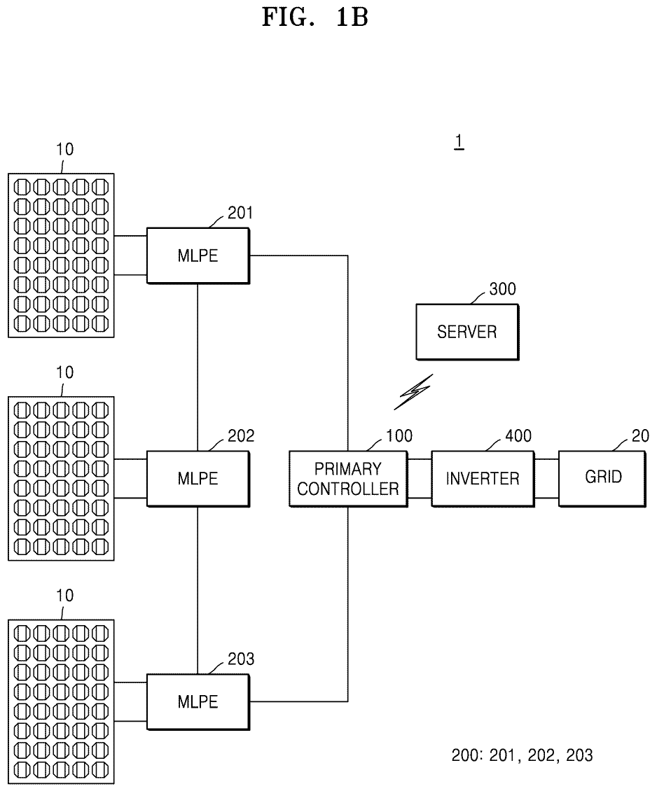

FIG. 1A and FIG. 1B are schematic diagrams of an example of a photovoltaic power generation system according to an embodiment of the present disclosure.

As shown in FIG. 1A, a photovoltaic power generation system according to an embodiment of the present disclosure may include a plurality of photovoltaic panels 10, an inverter 400 including a primary controller 100, a plurality of module-level power electronics (MLPE) devices 200, and a server 300. Alternatively, as shown in FIG. 1B, the photovoltaic power generation system according to another embodiment of the present disclosure may include the plurality of photovoltaic panels 10, the primary controller 100, the plurality of MLPE devices 200, the inverter 400, and the server 300.

The photovoltaic power generation system according to an embodiment may include the primary controller 100 in the inverter 400 as shown in FIG. 1A, or according to another embodiment, may include the inverter 400 between the primary controller 100 and a grid 20 as shown in FIG. 1B. Here, the inverter 400 may convert direct current (DC) power generated from the plurality of photovoltaic panels 10 into alternating current (AC) power and transmit the converted AC power to the grid 20. Hereinafter, for convenience, the following description will be based on an example in which the primary controller 100 is included in the inverter 400 as shown in FIG. 1A. Although the plurality of photovoltaic panels 10 and the plurality of MLPE devices 200 are collectively referred to below, the photovoltaic panels 10 and the MLPE devices 200 may be separate from each other and may include different types or models.

According to an embodiment, each of the plurality of photovoltaic panels 10 may mean a module-level photovoltaic power generation panel. The plurality of photovoltaic panels 10 may be connected in at least one of series and parallel, and the plurality of MLPE devices 200 may be respectively provided in the plurality of photovoltaic panels 10. Additionally, one MLPE device 200 may be connected to one photovoltaic panel 10, or one MLPE device 200 may be connected to the plurality of photovoltaic panels 10. The MLPE device 200 may transmit power generation information including a power generation amount, a temperature, and failure information of the photovoltaic panel 10 to the primary controller 100 and receive an operation command for optimizing power efficiency from the primary controller 100.

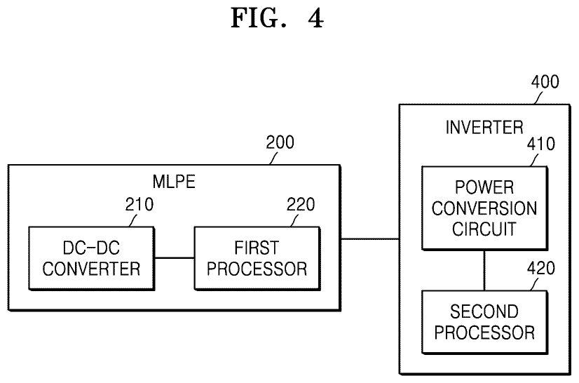

According to an embodiment of the present disclosure, the MLPE device 200 may be connected to each photovoltaic panel 10 to optimize the output power (output voltage) of each connected photovoltaic panel 10. The MLPE device 200 may optimize and output the output voltage of each connected photovoltaic (PV) module through a maximum power point tracking (MPPT) operation described below. A specific configuration of the MLPE device 200 will be described with reference to FIG. 4.

The MLPE device 200 may be connected to the photovoltaic panel 10 in a one-to-one correspondence as shown in FIG. 1, but may be installed in a many-to-one or many-to-many manner depending on a structure adopted by the photovoltaic power generation system 1, and an installation form thereof is not limited to any one of these.

According to an embodiment of the present disclosure, the plurality of MLPE devices 200 may be provided and may be connected in series with each other, and the inverter 400 or the primary controller 100 may be connected to opposite ends of the plurality of MLPE devices 200 connected in series.

According to an embodiment of the present disclosure, the inverter 400 may be mounted in a power conversion system (PCS) and perform power conversion to supply power produced from the photovoltaic panel 10 to a load or a system. As described above, the inverter 400 may include the primary controller 100 as shown in FIG. 1A, or may be provided separately from the primary controller 100 as shown in FIG. 1B. Hereinafter, for convenience, the following description will be based on an example in which the inverter 400 includes the primary controller 100 as shown in FIG. 1A will be described, and the operation of the inverter 400 may also be understood as the operation of the primary controller 100.

According to an embodiment of the present disclosure, the inverter 400 may identify a maximum power point voltage by performing an MPPT operation of tracking corresponding power and voltage when the photovoltaic power generation system 1 generates a maximum power. The MPPT operation may be an algorithm implemented to continuously adjust an impedance received by the photovoltaic panel 10 or an array including the plurality of photovoltaic panels 10 such that the photovoltaic power generation system 1 operates near the maximum power point when conditions such as a photovoltaic irradiance, a temperature, a load, etc., change. According to an embodiment of the present disclosure, the inverter 400 may control the MLPE device 200 to perform the MPPT operation and may maximize the power production efficiency of the photovoltaic power generation system 1. In addition, the inverter 400 may monitor an operation state by analyzing various data received from the photovoltaic panel 10, the MLPE device 200, a load, a grid, etc.

Meanwhile, according to an embodiment of the present disclosure, as the plurality of MLPE devices 200 are connected in series, assuming that the plurality of photovoltaic panels 10 and the plurality of MLPE devices 200 are of the same model, 1/N of the voltage applied to the entire inverter 400 may be applied to each of the N MLPE devices 200. In a specific embodiment, in case that a voltage control value of the MPPT operation controlled by the inverter 400 is 100 V and there are 10 photovoltaic panels 10 and 10 MLPE devices 200, a voltage applied to each of the MLPE devices 200 connected in series is equal to 10 V.

As described above, in the event of an abnormal situation in the photovoltaic power generation system 1, a shutdown signal may be generated to cut off the power. In more detail, in case that a DC-DC conductor of the MLPE device 200 is not mechanically rapidly cut off in the event of an abnormal situation in the photovoltaic power generation system, there is a high possibility of occurrence of a fire and thus a safety accident due to the nature of the photovoltaic power system installed outdoors. Therefore, to prevent these safety issues, there are mandatory regulations for rapid shutdown of photovoltaic systems, requiring the construction of safe photovoltaic power generation systems. For example, the National Electric Code (NEC) regulations require that a voltage not exceed 30 V within 10 seconds after start of the rapid shutdown.

However, it is realistically difficult for the MLPE devices 200 to receive a shutdown signal simultaneously or respond immediately upon generation of the shutdown signal, according to the rapid shutdown regulations. More specifically, as the plurality of MLPE devices 200 are connected in series with each other, the time required to perform an actual shutdown may vary for various reasons such as a transmission delay of a shutdown signal, a signal processing speed, etc.

In case that the output voltages of some MLPE devices 200 starting the shutdown first drop to 0 V in a very short time, the inverter 400 may set the existing total output voltage of the plurality of MLPE devices 200 to a fixed voltage due to the MPPT operation. Thus, even in case that some of the plurality of MLPE devices 200 are shut down first, the maximum power point voltage of the inverter 400 does not change, such that an overvoltage may be applied to the other MLPE devices 200 not yet being shut down, for example, an MLPE device 203. As a result, problems such as product damage may occur in the MLPE device 203 that is subjected to the overvoltage.

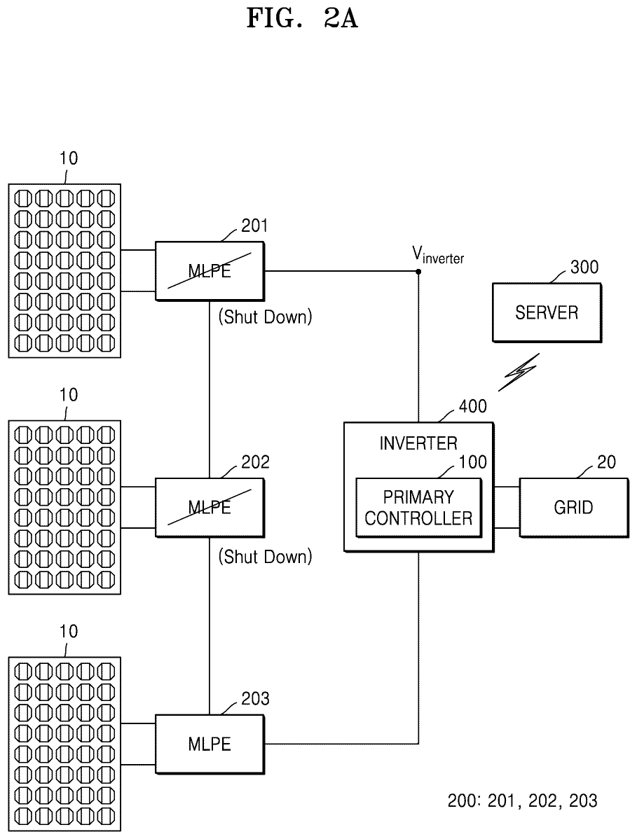

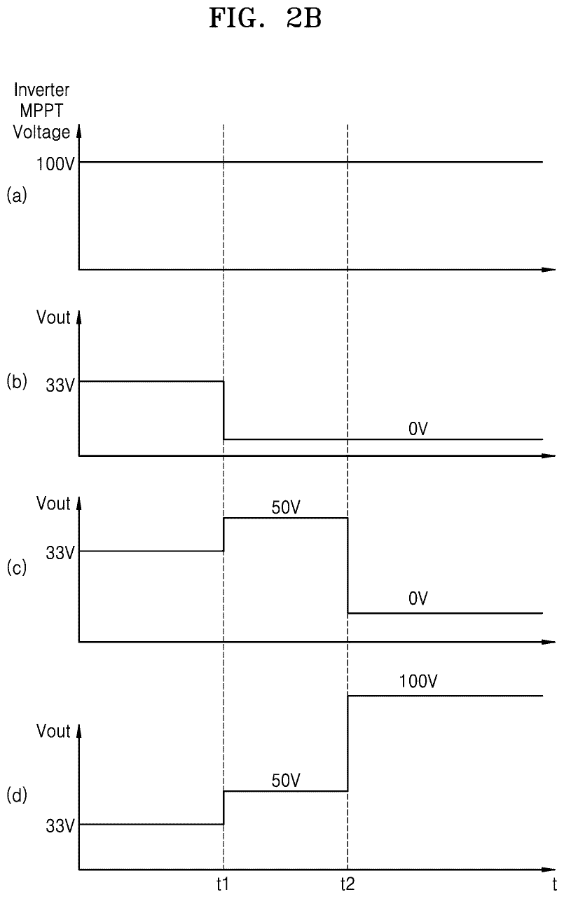

FIGS. 2A and 2B are views for describing damage that may occur during shutdown in a photovoltaic system.

Referring to FIG. 2A, assuming that an MPPT control voltage of the inverter 400 is 100 V, (100/3) V may be applied to each of the three MLPE devices 201, 202, and 203 during a normal operation. However, in case that a rapid shutdown is initiated due to occurrence of an abnormal situation in the photovoltaic system 1, the shutdown may be performed sequentially starting from the first MLPE device 201.

FIG. 2B shows graphs of output voltages of the inverter 400 and the MLPE device 200 in the event of an abnormal situation in the photovoltaic power system according to an embodiment of the present disclosure.

In FIG. 2B, (a) is a graph showing an MPPT control voltage of the inverter 400, (b) is a graph showing an output voltage of the first MLPE device 201, (c) is a graph showing an output voltage of the second MLPE device 202, and (d) is a graph showing an output voltage of the third MLPE device 203. More specifically, referring to (a) of FIG. 2B, the inverter 400 may maintain an MPPT control voltage of 100 V even in case of a shutdown. Also, referring to (b) of FIG. 2B, at a point in time t1, the first MLPE device 201 may be shut down, such that an output voltage, which was originally (100/3)V, suddenly drops to 0 V after t1. In this case, the output voltages of the second MLPE device 202 and the third MLPE device 203 not yet shut down may increase to 50 V after t1. At a point in time t2, the second MLPE device 202 may be shut down, causing the output voltage, which was originally 50 V, to drop sharply to 0 V. In this case, the output voltages of the second and third MLPE devices 203 not yet shut down may increase to 100 V after t2, increasing a possibility of product damage of the third MLPE device 203.

To overcome the product damage, according to an embodiment of the present disclosure, a method may be proposed to prevent an output overvoltage and product damage by gradually lowering the output voltage of the MLPE device 200 even in the event of an abnormal situation in the photovoltaic power system 1 by using a DC-DC converter used for power optimization of the MLPE device 200, thereby inducing the maximum power point voltage to be lowered according to the MPPT operation of the inverter 400.

Hereinafter, the operations of the photovoltaic power generation system 1 according to an embodiment of the present disclosure will be specifically described with reference to the drawings.

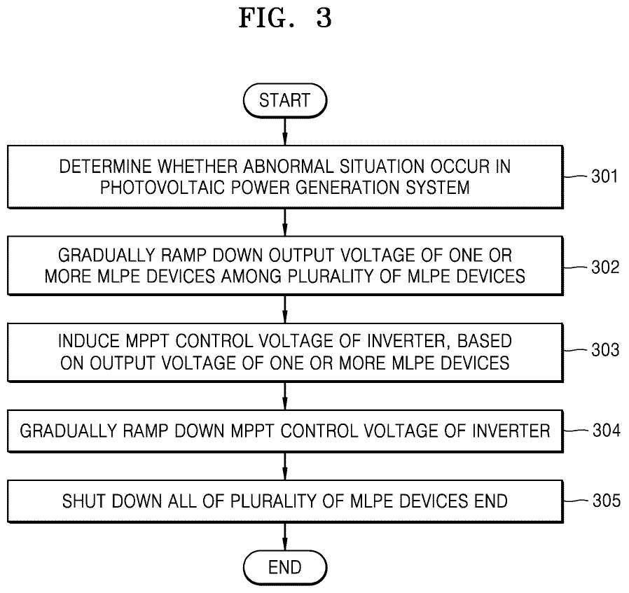

FIG. 3 is a flowchart of an example of an operating method of a photovoltaic system according to an embodiment of the present disclosure.

Each operation of FIG. 3 may be performed in the primary controller 100, the MLPE device 200, or the inverter 400 of the photovoltaic power generation system of the present disclosure. First, the operating method of the photovoltaic power generation system of the present disclosure may determine the occurrence of an abnormal situation in the photovoltaic power generation system, in operation 301.

Next, one or more of the plurality of MLPE devices 200 may gradually ramp down an output voltage in response to a shutdown signal, in operation 302. A gradual ramp-down command of the output voltage may be obtained from the primary controller 100 or the inverter 400.

Next, based on a gradual ramp-down of one or more MLPE output voltages, the MPPT control voltage of the inverter 400 may be induced in operation 303.

As the MPPT control voltage is induced, the MPPT control voltage of the inverter 400 may be gradually ramped down in operation 304.

Finally, all the MLPE devices 200 are shut down sequentially or in parallel.

Hereinbelow, the operating method of the photovoltaic power generation system of the present disclosure will be described in more detail through a specific configuration.

FIG. 4 is a block diagram of an MLPE device and an inverter according to an embodiment of the present disclosure.

According to an embodiment of the present disclosure, the MLPE device 200 may include a DC-DC converter 210 and a first processor 220. The inverter 130 may include a power conversion circuit 410 and a second processor 420.

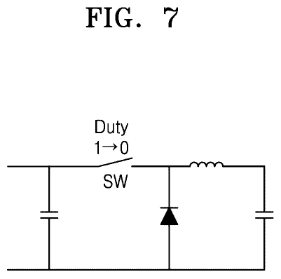

The DC-DC converter 210 according to an embodiment of the present disclosure may be implemented as a buck converter that ramps down a voltage (the output voltage of the photovoltaic panel 10) applied from the photovoltaic panel 10, and an example of the DC-DC converter 210 is illustrated in FIG. 7 below. The DC-DC converter 210 may have a duty cycle, which means a ratio at which the DC-DC converter 210 operates on in one cycle.

The first processor 220 according to an embodiment of the present disclosure may include, for example, a microcontroller unit (MCU) for power control. The processor 220 may execute software, such as a program, etc., to control at least one other component (e.g., a hardware or software component) of the MLPE device 200 and may process or compute various data.

The first processor 220 may perform serial communication with the inverter 400 or power line communication (PLC) to receive a control signal, a shutdown signal, etc., required for power optimization.

The first processor 220 may receive a shutdown signal from the inverter 400 that monitors in overall the operation state of the photovoltaic power generation system 1, but the present disclosure is not limited thereto.

For example, the first processor 220 may monitor the operation state, etc., of each MLPE device and generate a shutdown signal upon detection of an abnormal situation. Specifically, the first processor 220 may also analyze various data received from the photovoltaic panel 10, internal operation data of the MLPE device 200, a load, a system, etc., to monitor the operation state and generate a shutdown signal in the event of an abnormal situation.

According to an embodiment of the present disclosure, the first processor 220 may control the duty ratio of the DC-DC converter 210 according to the shutdown signal to convert (regulate) the output voltage of the MLPE device 200. The duty ratio of the DC-DC converter 210 may be controlled directly by the first processor 220 or according to a command from the primary controller 100 or inverter 400.

According to an embodiment of the present disclosure, the inverter 400 may include the power conversion circuit 410 and the second processor 420. As described above, the inverter 400 may include the primary controller 100 or may be provided separately from the primary controller 100. In case that the inverter 400 includes the primary controller 100, the second processor 420 of the inverter 400 may be a processor of the primary controller 100. In case that the inverter 400 is provided separately from the primary controller 100, the second processor 420 may operate according to the control command of the primary controller 100.

The power conversion circuit 410 may convert an output voltage DC applied from the photovoltaic panel 10 or the MLPE module 200 into an alternating current voltage AC to transmit the output voltage DC to a load or a system.

The second processor 420 may be implemented as an MCU for power control like the first processor 220, and may perform conversion control through the power conversion circuit 410 or analyze various data received from the photovoltaic panel 10, the MLPE device 200, the load, the system, etc., to monitor the operation state.

The second processor 420 may perform an MPPT operation and maximize the power production efficiency of the photovoltaic power generation system 1 and transmit a shutdown signal to the plurality of MLPE devices 200 in the event of an abnormal situation.

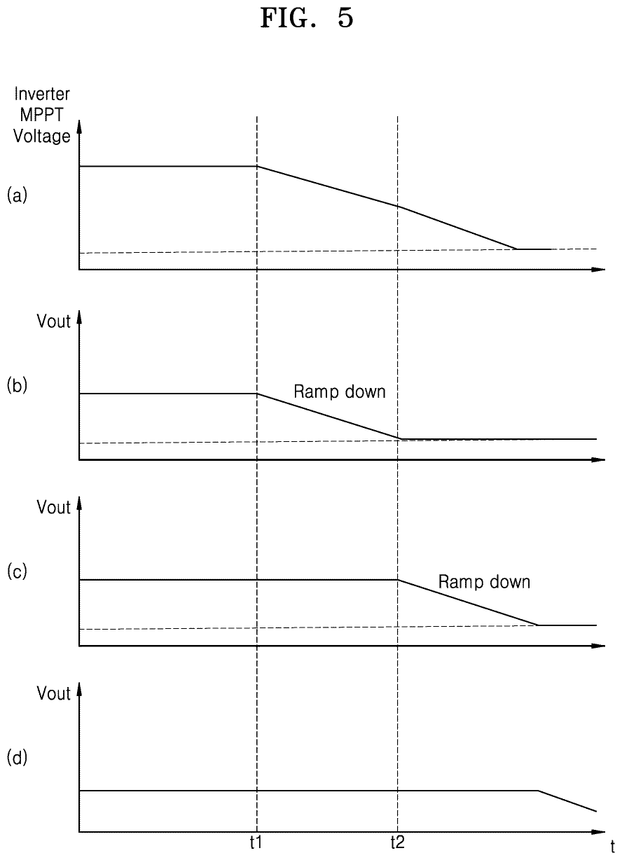

FIG. 5 is a graph for describing operations of an inverter and an MLPE device in the event of an abnormal situation in a photovoltaic system according to an embodiment of the present disclosure.

Referring to FIG. 5, a graph showing an MPPT voltage control induced waveform of the inverter 400 according to a shutdown of a system according to an embodiment of the present disclosure and an output voltage of the MLPE device 200 according to a gradual voltage drop of the inverter 400 is shown.

Hereinafter, the operations of the MLPE device 200 and the inverter 400 may be assumed to be controlled by the first processor 220 and the second processor 420, respectively, although not specified.

According to an embodiment of the present disclosure, in the event of an abnormal situation in the photovoltaic system 1, the MLPE device 200 may gradually ramp down the output voltage in the event of a shutdown, and the inverter 400 may also gradually reduce the MPPT control voltage.

That is, each MLPE device 200 may control the duty ratio of the DC-DC converter 210 to gradually lower the output voltage from the shutdown point t1 even in case that the shutdown signal is generated. Specifically, according to an embodiment of the present disclosure, at least one of the plurality of MLPE devices 200 may gradually lower the output voltage of at least one MLPE device by controlling the duty ratio from t1 when a duty ratio control operation starts according to the shutdown signal.

The inverter 400 may also start the MPPT control operation almost simultaneously, i.e., at t1, in response to the voltage ramp-down operation of the MLPE device 201 due to the shutdown. In FIG. 5, as the inverter 400 may perform MPPT voltage control by almost identically following the MLPE device 201 starting a voltage drop, the output voltages of the MLPE devices 202 and 203 may not be affected in spite of the shutdown of the MLPE device 201.

Similarly, even in case that the shutdown and voltage drop of the MLPE device 202 start at t2 after termination of the shutdown of the MLPE device 201, the inverter 400 may follow the MLPE device 202 almost identically, such that the output voltages of the MLPE devices 201 and 203 may not be affected.

In this way, by gradually decreasing the output voltage of the MLPE device where a shutdown occurs, it is possible to prevent product damage from occurring due to a sudden increase in the output voltage caused by the MPPT operation of the inverter.

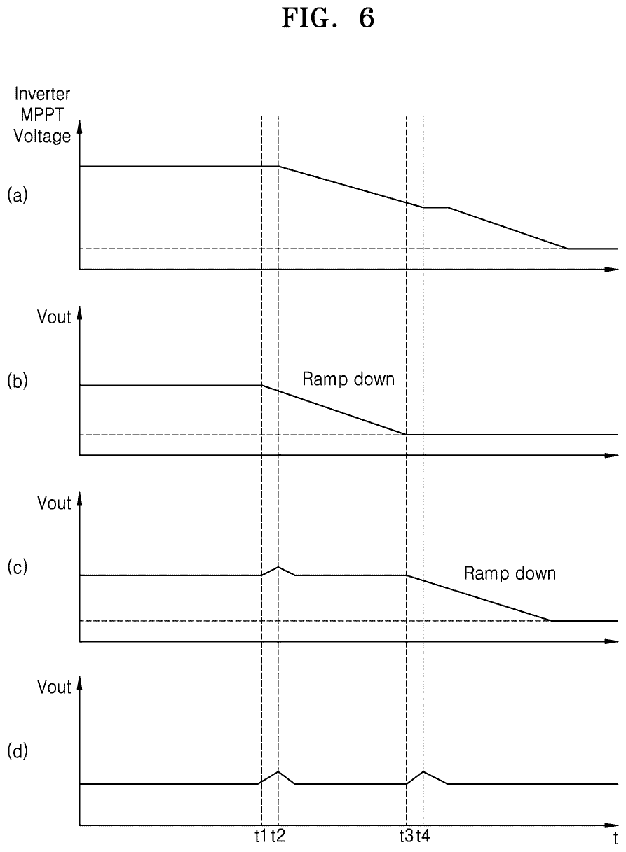

FIG. 6 is a graph for describing operations of an inverter and an MLPE device in the event of an abnormal situation in a system according to another embodiment of the present disclosure.

More specifically, FIG. 6 is a graph showing an MPPT voltage control induced waveform of the inverter 400 according to a shutdown of a system according to an embodiment of the present disclosure and an output voltage of the MLPE device 200 according to a gradual voltage drop of the inverter 400.

Hereinafter, the operations of the MLPE device 200 and the inverter 400 may be assumed to be controlled by the first processor 220 and the second processor 420, respectively, although not specified.

According to an embodiment of the present disclosure, in the event of an abnormal situation in the photovoltaic system 1, the MLPE device 200 may gradually ramp down the output voltage in the event of a shutdown, and the inverter 400 may also gradually reduce the MPPT control voltage. That is, each MLPE device 200 may control the duty ratio of the DC-DC converter 210 to gradually lower the output voltage even in case that the shutdown signal is generated. That is, according to an embodiment of the present disclosure, even in case that the MLPE devices 200 connected in series sequentially perform the shutdown function, product damage may be prevented by ensuring that the output voltage of the MLPE device 200 not yet shut down does not become an overvoltage.

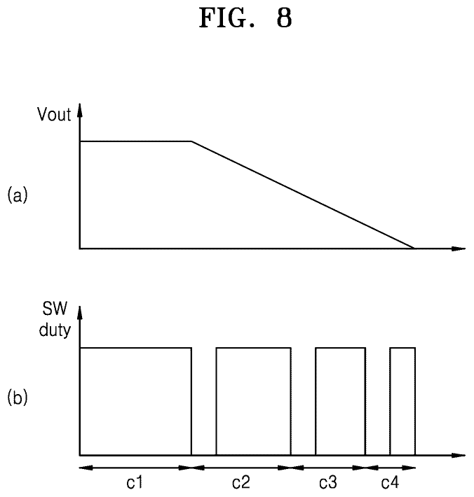

Specifically, according to an embodiment of the present disclosure, at least one of the plurality of MLPE devices 200 may gradually lower the output voltage of the at least one MLPE device by controlling the duty ratio from a point in time (hereinafter, referred to as a first tie point) to start duty ratio control according to the shutdown signal. Matters related to the duty ratio control will be described with reference to FIGS. 7 and 8.

Meanwhile, it may take time for the inverter 400 to perform the MPPT operation in response to the ramp-down operation of the MLPE device 200 due to the shutdown. Thus, the inverter 400 may gradually lower a maximum power point voltage to correspond to the output voltage of the at least one MLPE device 200 from a point in time (hereinafter, referred to as a second point in time) at which the MPPT operation starts after a selected time from the first point in time. However, the selected time (the time taken to respond) may vary depending on a situation or component conditions, and the time taken to respond may be very short.

The output voltage of the other MLPE devices 200 among the plurality of MLPE devices for which the shutdown has not started may instantaneously increase in response to the maximum power point voltage of the inverter 400 between the first point in time and the second point in time. However, as a voltage value increasing instantaneously between the first point in time and the second point in time may be a voltage value dropped by at least one MLPE device 200 that is being shut down, the voltage value may not have a significant influence on the other MLPE devices 200.

The above-described matters will be described with reference to the graph in FIG. 6 as follows.

According to an embodiment of the present disclosure, (a) of FIG. 6 is a graph showing an MPPT control voltage (i.e., an MPPT voltage control induced waveform) of the inverter 400, and (b) to (d) of FIG. 6 are graphs showing the output voltage of each MLPE device in case that there are three MLPE devices 201, 202, and 203.

In case that a shutdown signal is generated, each MLPE device 200 may gradually lower the output voltage of each MLPE device 200 by controlling the duty ratio of the built-in DC-DC converter 210, thereby inducing the inverter 400 to lower the MPPT control voltage.

First, in the event of an abnormal situation in the photovoltaic power system 1, according to an embodiment of the present disclosure, the output voltage of each MLPE device 200 may be gradually ramped down rather than immediately be ramped down to 0 V in spite of a shutdown. More specifically, according to an embodiment of the present disclosure, from a point in time at which at least one MLPE device (e.g., the MLPE device 201 of FIG. 6) among the plurality of MLPE devices is shut down, that is, t1, duty ratio control may start, and the output voltage of the MLPE device 201 may be gradually lowered according to the duty ratio control. As a result, the voltage of the MLPE device 201 may be gradually ramped down during a period from t1 to t3, and the output voltage of the MLPE device 201 may become 0 V at t 3 when the MLPE device 201 is completely shut down.

Meanwhile, according to an embodiment of the present disclosure, it may take time for the inverter 400 to perform the MPPT operation in response to the ramp-down operation of the MLPE device 201 due to the shutdown (the period from t1 to t2). Thus, the MPPT control voltage of the inverter 400 may be constant in the period from t1 to t2, and the output voltages of the other MLPE devices (the MLPE device 202 and the MLPE device 203 of FIG. 6) for which the shutdown has not started among the plurality of MLPE devices may instantaneously increase in response to the maximum power point voltage of the inverter 400 from t1 to t2 at which the inverter 400 starts the MPPT operation (the period from t1 to t2).

However, as the voltage value that increases instantaneously may be the voltage value dropped by the MLPE device 201 that is being shut down in the period from t1 to t2, the voltage value may not have a significant effect on the voltage increase due to the MPPT operations of the other MLPE device 202 and MLPE device 203.

Thus, the inverter 400 may gradually lower the MPPT control voltage in response to the output voltage of the MLPE device 201 from t2 (a period from t2 to t4). That is, t2 may be the point in time at which the inverter 40 starts to drop the MPPT control voltage in response to the shutdown of the MLPE device 201, and t4 may be the point in time at which the inverter 400 starts to lower the MPPT control voltage in response to the shutdown of the MLPE device 202.

Likewise, in a subsequent process, in case that the MLPE device 202 starts duty ratio control with a time difference from the MLPE device 201, the output voltage of the MLPE device 203 may increase slightly during the period from t3 to t4, but the output voltage may not have an influence to the extent of causing damage. The output voltage of each MLPE device may not exceed a preset value until the shutdown of all the MLPE devices is completed. The inverter 400 may gradually lower the MPPT control voltage after a time required for a certain response to a gradual drop of the output voltage of the MLPE device 202, as the example described above.

In FIG. 6, it is illustrated that the MLPE devices sequentially perform a shutdown one by one, and the shutdown of the next MLPE device may start after the shutdown of one MLPE is completed, but it is obvious that the present disclosure is not limited thereto. Thus, according to another embodiment of the present disclosure, the plurality of MLPE devices may be shut down simultaneously or in parallel.

According to an embodiment of the present disclosure described above, it is possible to prevent damage to components due to an instantaneous overvoltage in a rapid shutdown situation.

According to an embodiment of the present disclosure, the output voltage of the MLPE device 200 may be gradually ramped down even in case of a shutdown by using the DC-DC converter 210 already provided in the MLPE device 200 for power optimization, such that that overvoltage prevention and damage prevention may be performed without having an additional device to prevent product damage, which is efficient in terms of cost and installation.

According to an embodiment of the present disclosure, even in case that the manufacturers of the photovoltaic panel 10, the MLPE device 200, and the inverter 400 are different, the present disclosure may be applied, which is a general-purpose and economical technology.

FIG. 7 is a circuit diagram of a direct current-to-direct current (DC-DC) converter of an MLPE device according to an embodiment of the present disclosure.

According to an embodiment of the present disclosure, a processor of the MLPE device 200 may gradually lower the output voltage of each MLPE device 200 by adjusting the duty ratio of a switch SW of the DC-DC converter from 1 to 0. The output voltage drop with respect to the duty ratio is shown in FIG. 8.

The DC-DC converter circuit is not limited to that shown in FIG. 7, and may be designed such that the output voltage of the photovoltaic panel 10 (the voltage applied to the DC-DC converter) drops to a desired output voltage according to a defined protocol (e.g., 30 V or less within 30 seconds).

FIG. 8 is a graph showing an output voltage of an MLPE device with respect to duty ratio control according to an embodiment of the present disclosure.

In FIG. 8, (a) is a graph of the output voltage of an MLPE device according to an embodiment of the present disclosure, and (b) is a graph showing how the duty ratio changes.

Each MLPE device 200 may control the output voltage of each MLPE device by applying a switch on/off signal to the DC-DC converter. The switch on/off signal may be a pulse width modulation (PWM) control signal. As described above, each MLPE device 200 may lower the output voltage by adjusting a switch duty according to the defined protocol (e.g., below 30 V within 30 seconds).

Referring to FIG. 8, it may be seen that the duty ratio in a first cycle c1 is 1 and thus the MLPE device is in a normal operation state. However, from a second cycle c2, an off value may appear, such that it may be seen that the duty ratio is less than 1. It may be seen that as the cycle is repeated, the length of the off value becomes greater than the cycle length, and thus the duty ratio gradually decreases. In this way, the MLPE device 200 according to an embodiment of the present disclosure may obtain a gradually ramped-down output voltage using a DC-DC converter, even in the event of a shutdown.

According to an embodiment of the present disclosure, the DC-DC converter used to optimize the output voltage of the PV module may also be used for the shutdown, thereby preventing component damage without additional cost.

### Explanation Of Reference Numerals Designating The Major Elements of The Drawings

1: Photovoltaic power generation system
10: PV module
200: MLPE
400: Inverter

1. An operating method of a photovoltaic power generation system, the operating method comprising:
determining whether an abnormal situation occurs in the photovoltaic power generation system;
gradually ramping down an output voltage of one or more module-level power electronics (MLPE) devices among a plurality of MLPE devices;
inducing a maximum power point tracking (MPPT) control voltage of an inverter, based on the output voltage of the one or more MLPE devices; and
all of the plurality of MLPE devices being shut down.

2. The operating method of claim 1, wherein the inducing of the MPPT control voltage of the inverter comprises gradually ramping down the MPPT control voltage of the inverter to correspond to a gradual ramp-down of the output voltage of the one or more MLPE devices.

3. The operating method of claim 1, wherein the gradual ramping down of the output voltage of the one or more of the MLPE devices comprises controlling a duty ratio of a direct current-to-direct current (DC-DC) converter provided in the one or more MLPE devices according to a shutdown signal in response to the occurrence of the abnormal situation in the photovoltaic power generation system.

4. The operating method of claim 3, wherein the duty ratio of the DC-DC converter is controlled to decrease from 1 to 0 over time.

5. The operating method of claim 1, wherein the MPPT control voltage of the inverter starts to be ramped down from a second point in time after a lapse of a selected time from a first point in time at which an output voltage of one of the plurality of MLPE devices starts to be ramped down.

6. The operating method of claim 5, wherein an output voltage of one or more MLPE devices which are not shut down during a period between the first point in time and the second point in time increases in response to the MPPT control voltage of the inverter.

7. The operating method of claim 1, wherein the plurality of MLPE devices are connected in series with each other.

8. The operating method of claim 1, wherein output voltages of the plurality of MLPE devices do not exceed a preset value from a point in time at which the abnormal situation occurs in the photovoltaic power generation system until a point in time at which all of the plurality of MLPE devices are shut down.

9. An inverter for a photovoltaic power generation system, the inverter comprising:
a power conversion circuit; and
a processor,
wherein the processor is configured to:
determine whether an abnormal situation occurs in the photovoltaic power generation system;
gradually ramp down an output voltage of one or more module-level power electronics (MLPE) devices among a plurality of MLPE devices; and
induce a gradual ramp-down of a maximum power point tracking (MPPT) control voltage of an inverter, based on the output voltage of the one or more MLPE devices.

10. The inverter of claim 9, wherein the processor is further configured to control a duty ratio of a direct current-to-direct current (DC-DC) converter provided in the one or more MLPE devices to induce the inverter to lower the MPPT control voltage in response to the output voltage of the one or more MLPE device being lowered, in case that a shutdown signal for cutting off power is generated upon the occurrence of the abnormal situation.

11. The inverter of claim 10, wherein the duty ratio of the DC-DC converter is controlled to decrease from 1 to 0 over time.

12. The inverter of claim 9, wherein the plurality of MLPE devices are configured to optimize an output voltage of a photovoltaic module connected to the plurality of MLPE devices with an output voltage of each MLPE device through an MPPT operation.

13. The inverter of claim 9, wherein the output voltage of the one or more MLPE devices among the plurality of MLPE devices is gradually ramped down from a first point in time at which a duty ratio control operation starts according to a shutdown signal.

14. The inverter of claim 13, wherein the inverter is further configured to gradually lower the MPPT control voltage in response to the output voltage of the one or more MLPE devices from a second point in time at which an MPPT control operation starts after a selected time from the first point in time.

15. The inverter of claim 14, wherein an output voltage of an MLPE device which is not shut down among the plurality of MLPE devices instantaneously increases between the first point in time and the second point in time in response to the MPPT control voltage of the inverter.

16. The inverter of claim 9, wherein the plurality of MLPE devices are connected in series with each other.

17. The inverter of claim 9, wherein output voltages of the plurality of MLPE devices do not exceed a preset value from a point in time at which the abnormal situation occurs in the photovoltaic power generation system until a point in time at which all of the plurality of MLPE devices are shut down.

18. A primary controller of a photovoltaic power generation system, the primary controller comprising:
a communication unit configured to transmit a control signal to a plurality of module-level power electronics (MLPE) devices and receive a monitoring signal from the plurality of MLPE devices; and
a processor configured to determine whether an abnormal situation occurs in the photovoltaic power generation system, gradually ramp down an output voltage of one or more MLPE devices among the plurality of MLPE devices, and induce a gradual ramp-down of a maximum power point tracking (MPPT) control voltage of an inverter, based on the output voltage of the one or more MLPE devices.

19. The primary controller of claim 18, wherein the processor is further configured to generate a signal for controlling a duty ratio of a direct current-to-direct current (DC-DC) converter provided in the one or more MLPE devices, according to a shutdown signal corresponding to the occurrence of the abnormal situation in the photovoltaic power generation system, to gradually ramp down the output voltage of the one or more MLPE devices.

20. The primary controller of claim 18, wherein output voltages of the plurality of MLPE devices do not exceed a preset value from a point in time at which the abnormal situation occurs in the photovoltaic power generation system until a point in time at which all of the plurality of MLPE devices are shut down.
